(19) United States
(12) Patent Application Publication
(10) Pub. No.: US 2020/0198888 A1
(43) Pub. Date: Jun. 25, 2020

(54) BOLT-ON REAR LOADER ATTACHMENT

(71) Applicant: Curbtender, Inc., Cedar Falls, IA (US)

(72) Inventor: David Alan Steimel, Waterloo, IA (US)

(21) Appl. No.: 16/227,589

(22) Filed: Dec. 20, 2018

(51) Int. Cl. B65F 3/04; B66D 1/60

(52) U.S. Cl. CPC B65F 3/04; B66D 1/60; B65F 2003/0263; B66D 2700/0141; B66D 2700/0133

(57) ABSTRACT

A removably attachable rear loader attachment mechanism for attaching to a standard stock rear end refuse collection vehicle body, the removably attachable rear loader attachment including a pair of latch assemblies removably attachable to flanges associated with the rear end portion of the vehicle body, a hopper extension member removably attachable to the rear end portion of the vehicle body, a roller bar assembly having a pair of roller bar frame members each removably attachable to the respective removably attachable latch assemblies, and a hydraulic source attachable to the latch assemblies and to the roller bar assembly for moving such members for capturing and dumping a commercial container into the storage compartment of the refuse collection vehicle. A removably attachable winch mechanism is also removably attachable to the top portion of a standard stock rear end refuse collection vehicle body for aiding in the dumping of a commercial container.

### BACKGROUND OF THE INVENTION

The present invention relates generally to a refuse collection vehicle and, more particularly, to a refuse collection vehicle having a stock body which enables a dealer or other user to customize the rear end portion of the refuse collection vehicle with a rear loader attachment for lifting and dumping various types of commercial containers. The present design allows a dealer or other user to customize the vehicle after the fact more easily for local market needs.

Various types of refuse collection vehicles are well known in the industry. These vehicles include, among other things, a storage compartment and a mechanism for emptying the refuse material collected within the storage compartment. Some of these vehicles include a receiving hopper typically located forward of the storage compartment, the receiving hopper being designed to receive the refuse material when loaded within the vehicle body. Depending upon the local market needs, many of these vehicles are customized so as to receive and dump commercial containers or dumpsters located at various business sites. Typically, the rear loader attachment for capturing and dumping commercial containers is welded to the rear portion of the refuse collection vehicle thereby restricting that particular vehicle to a particular rear loader attachment and further restricting that vehicle to receiving and dumping only commercial containers.

It is therefore desirable to have a bolt-on rear loader attachment for receiving and dumping commercial containers which is not permanently attached to the rear end portion of a refuse collection vehicle and which can be easily attached to and detached from a stock rear end portion of a refuse collection vehicle so that the dealer or other user can easily change the performance of the vehicle to meet the needs of their changing route dynamics.

The present invention therefore seeks to overcome the shortcomings and disadvantages associated with permanently attaching rear loader attachments to a refuse collection vehicle by providing a bolt-on rear loader attachment as well as a bolt-on winch assembly which are typically used for receiving and dumping commercial containers.

### SUMMARY OF THE INVENTION

According to one aspect of the present invention, there is provide a refuse collection vehicle having a standard stock rear end body which will allow for a rear loader attachment to be removably attached to the standard stock rear end vehicle body so that the vehicle can be transformed into receiving and dumping commercial containers. The present bolt-on rear loader attachment includes a curb side latch assembly and a street side latch assembly which can be easily bolted to a standard stock rear end portion of a refuse collection vehicle. The present design likewise includes a hopper extension member which can likewise be easily attached to and removed from the rear end portion of the refuse collection vehicle and further includes a bolt-on roll bar assembly for facilitating the lifting and dumping of a commercial container. These assemblies can be easily attached to and removed from a standard stock rear end portion of a refuse collection vehicle.

In addition, in some instances, a winch mechanism may likewise be utilized to dump certain types of commercial containers. The present invention further includes a bolt-on winch assembly which attaches to the upper portion of a standard stock refuse collection body, the bolt-on winch assembly including a winch mounting cross frame member, a winch mounting frame member, and a winch attached to the winch mounting frame member for attaching to the upper end portion of a standard stock vehicle body.

Additional features of the present invention will be described in the course of the following detailed description.

### BRIEF DESCRIPTION OF THE DRAWINGS

For a better understanding of the present invention, reference may be made to the following accompanying drawings.

FIG. 1 is a perspective view of the rear end portion of a standard stock refuse collection vehicle body showing the bolt-on latch assembly and hopper extension member of the present invention in exploded view.

FIG. 2 is a perspective view of the rear end portion of a standard stock refuse collection vehicle body showing the bolt-on latch assembly attached to the vehicle and showing the bolt-on roll bar assembly of the present invention in exploded view.

FIG. 3 is a perspective view of the flange member associated with the bolt-on roll bar assembly of the present invention.

FIG. 4 is a perspective view similar to FIG. 1 showing the rotating arm member of one of the latch assemblies in its open position.

FIG. 5 is a perspective view of the top end portion of a standard stock refuse collection vehicle body showing the bolt-on winch assembly of the present invention attached to the vehicle.

While the present disclosure is susceptible to various modifications and alternative forms, a specific embodiment of the present invention is shown by way of example in the present drawings and will herein be described in detail. It should be understood, however, that the present drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION OF THE INVENTION

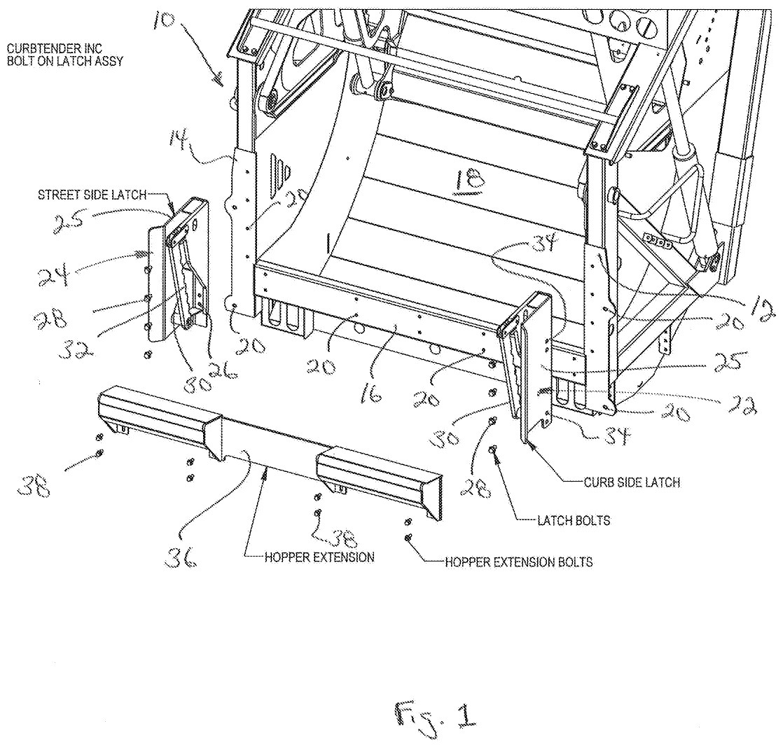

Referring to the drawings more particularly by reference numbers wherein like numerals refer to like parts, the number 10 in FIG. 1 illustrates the rear end portion of a stock refuse collection vehicle having a curb side flange member 12, a street side flange member 14 and a rear cross member 16 extending therebetween. The stock body rear end portion 10 likewise includes an opening 18 to the storage compartment of the refuse collection vehicle as well as the hydraulic mechanisms necessary to open and close the tailgate assembly associated with a typical refuse collection vehicle. A plurality of strategically positioned openings or apertures 20 are associated with the flange members 12, 14 and cross member 16 so that the present bolt-on rear loader attachment assembly can be attached to the rear end portion of the vehicle as will be hereinafter explained.

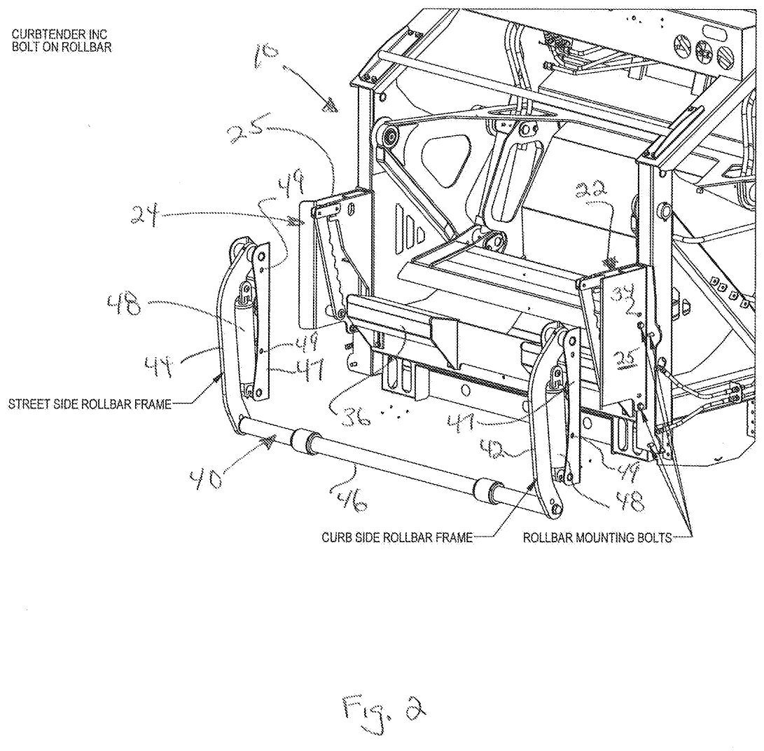

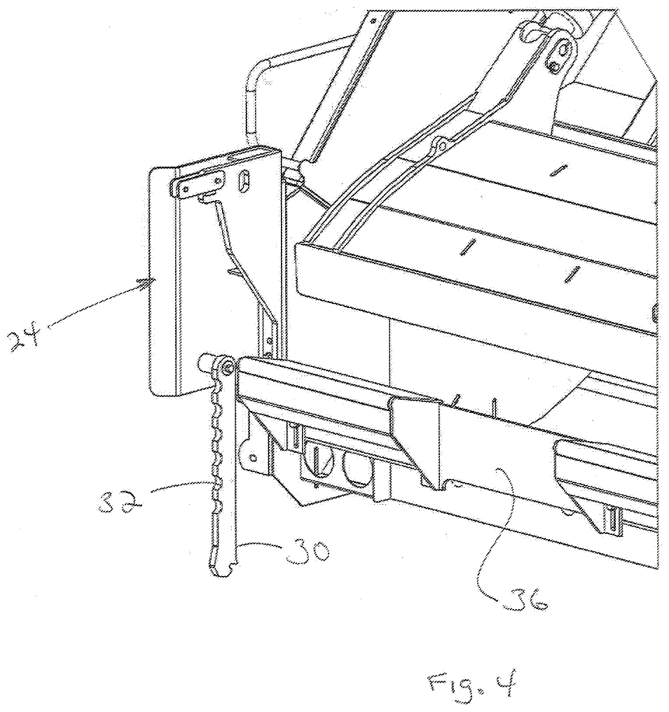

The present invention includes a curb side latch assembly 22 and a street side latch assembly 24 which likewise includes a plurality of corresponding openings or apertures 26 which enable the curb side and street side latch assemblies to be bolted directly to the flange members 12 and 14. The latch assemblies 22 and 24 are bolted to members 12 and 14 through a plurality of latch bolts 28. The latch assemblies 22 and 24 each include a rotating arm member 30 which can be manually manipulated by the vehicle driver to capture a corresponding roll bar (not shown) associated with a typical commercial container. The rotating arm members 30 each likewise include a plurality of scoops or cutouts 32 for receiving the roll bar associated with a typical commercial container. Each arm member 30 is movable between an open position as illustrated in FIG. 4 and a latched position as illustrated in FIGS. 1 and 2. Still further, each of the latch assemblies 22 and 24 likewise includes strategically positioned openings or apertures 34 on a frame member 25 for allowing the roll bar assembly 40 (FIG. 2) to likewise be removably attached to the pair of latch assemblies 22 and 24 as will be hereinafter further explained.

Depending upon the type of commercial containers being captured and dumped by the refuse collection vehicle, a wide variety of different types of hopper extension members 36 can likewise be attached to the rear end portion of the refuse vehicle 10. As illustrated in FIG. 1, hopper extension member 36 is likewise removably bolted to the rear cross member 16 using a plurality of attaching bolts 38.

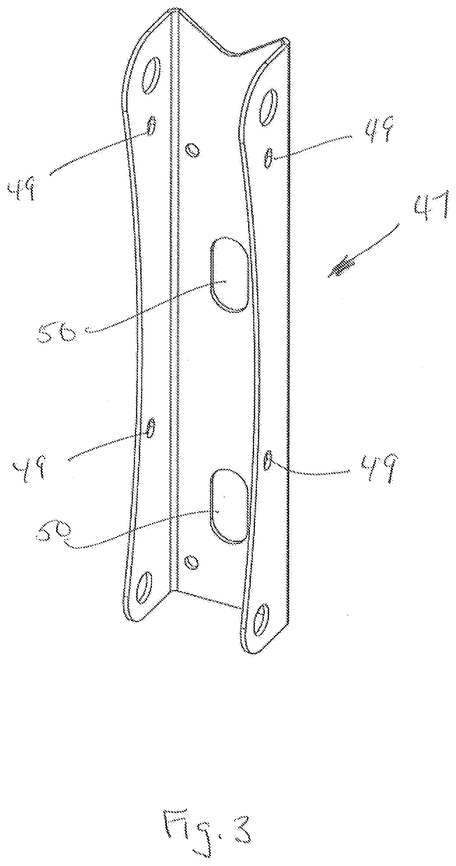

Once the curb side latch assembly 22 and the street side latch assembly 24 are removably attached to flanges 12 and 14, and once the hopper extension member 36 is attached to cross member 16, the bolt-on roll bar assembly 40 can be attached directly to the latch assemblies 22 and 24 as illustrated in FIG. 2. To this end, the present bolt-on roll bar assembly 40 includes a curb side roll bar frame member 42, a street side roll bar frame member 44 and roll bar 46. Each roll bar frame member is pivotally attached to a corresponding channel flange member 47 each of which includes a hydraulic cylinder 48 for pivotally moving the roll bar 46 between a first position adjacent the respective hydraulic cylinders 48 as illustrated in FIG. 2 and a second position angularly related thereto for either lifting or tilting a particular commercial container for dumping into the storage compartment 18 of a typical refuse collection vehicle. Each of the channel flange members 47 includes a plurality of openings or apertures 49 for allowing the flange members 47 to be removably attached directly to the latch assemblies 22 and 24. To this end, each latch assembly 22 and 24 includes a frame member 25 to which the flange members 47 attach to as best shown in FIGS. 1 and 2. Each of the flange members 47 likewise includes openings 50 (FIG. 3) associated with the rear end portion thereof for allowing hydraulic lines to be connected to both the latch assemblies 22 and 24 for moving the latch arm members 30 as well as to the hydraulic cylinders 48 for moving the roll bar 46 between its first and second positions. Once the roll bar assembly 40 is attached to the pair of latch assemblies, the rear loader attachment mechanism is ready for operational use.

In one aspect of capturing and dumping a particular style of commercial container, the vehicle operator will rotate and open the respective latch arm members 30 associated with each latch assembly 22 and 24 as best illustrated in FIG. 4 such that the roll bar associated with the container or dumpster assembly can be positioned for being captured by the cutouts or scallops 32 associated with rotating arm members 30 when the members 30 are rotated upwardly into their capture position. Once the roll bar of the commercial container is captured by the respective latch arm members 30, the commercial container or dumpster can be lifted, rotated and dumped into the storage compartment of the refuse collection vehicle by hydraulically manipulating the roll bar 46 which will be positioned adjacent the side wall portion of the commercial container facing the rear portion of the refuse collection vehicle. The operator of the vehicle can manipulate the positioning of the roll bar 46 from its first position to its fully extended second position for both lifting, rotating and dumping any refuse material contained within the commercial container into the storage compartment of the vehicle. The capturing and dumping of the commercial container including hydraulically manipulating the movement of the roll bar 46 can be accomplished in a conventional manner.

In another aspect of the present invention, some commercial containers require the use of a winch mechanism in order to lift and rotate the commercial container into a position for dumping any refuse material contained therein into the storage compartment 18 of a typical refuse collection vehicle. The present invention also includes a removably attachable winch mechanism 52 which again can be removably attached to a standard stock refuse collection vehicle body without the need for permanently attaching the winch mechanism to the vehicle. This again gives a dealer and/or user more flexibility in customizing the rear end portion of the refuse collection vehicle depending upon the type of commercial containers to be captured and dumped and depending upon local market needs.

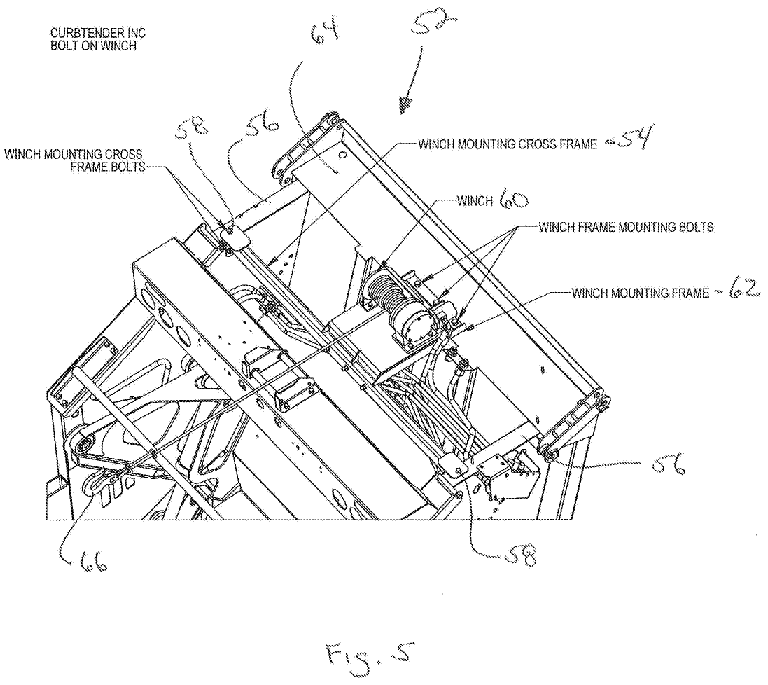

As best illustrated in FIG. 5, the present invention likewise includes a winch mounting cross frame 54 which is attached to flange members 56 associated with a standard vehicle body through the use of connecting bolts 58. A winch mechanism 60 is mounted to a winch mounting frame 62 and the mounting frame 62 is attached directly to the top rear end portion of a standard stock refuse collection vehicle body by attaching one end portion of the winch mounting frame to the cross frame member 54 and attaching its opposite end portion to the cross flange member 64 associated with the top end portion of the standard stock vehicle body. Here again, openings or apertures are strategically placed on the cross frame member 58, the winch mounting frame member 62 and the vehicle flange member 64 so that the winch mechanism 52 can be easily bolted onto the top portion of the vehicle. Appropriate hydraulic and electrical connections are attached to the winch mechanism in a conventional manner.

In operation, the hook portion 66 of the winch 60 is attached to one side portion of a typical commercial container and the roll bar associated with its opposite end portion is attached to the latch assemblies 22 and 24 in a conventional manner as previously explained. The winch 60 is then utilized to rotate the commercial container about its roll bar captured within the latch assemblies 22 and 24, and the roll bar frame assembly 40 is then rotated such that roll bar 46 engages the back side of the commercial container and facilitates the dumping of the refuse material from the commercial container into the storage compartment of the vehicle. Here again, this dumping operation is done is a conventional manner using the winch mechanism 52.

Use of the present removably attachable rear loader attachment and the removably attachable winch mechanism enables dealers and daily users of refuse collection vehicles to customize their vehicles depending upon the particular type of commercial container needed to be collected and dumped as well as depending upon local market needs and changing route dynamics such that the same refuse collection vehicle can be used and adapted to a wide variety of different dumping applications. This greatly improves the flexibility of the dealer, user and the particular refuse collection vehicle and eliminates the need for having a particular type of rear loader attachment mechanism permanently mounted and/or welded to the refuse collection vehicle. Obviously, a permanently mounted attachment limits the use of that particular vehicle to one particular type of a dumping operation. The present invention allows a dealer and user to remove the present bolt-on rear loader attachments as well as the winch mechanism so that the refuse collection vehicle can be used for other applications.

It is also recognized and anticipated that the overall shape and dimensions of the various components associated with the present rear loader attachment including the curb side and street side latch assemblies 22 and 24, the rear hopper extension member 36, and the roll bar assembly 40 are all subject to wide variations and may be sized and shaped into a wide variety of different sizes and configurations so as to be compatible with and attachable to the rear end portion of a standard stock refuse collection vehicle body. The same is likewise true with the various components associated with the winch mechanism 52. In addition, other attachment means other than bolts may likewise be used to attach the various components of the present invention to the rear end portion of a standard stock vehicle body so long as the attachment means are removable such that the present rear loader attachment mechanism and the present winch mechanism can be attached to and easily removed from the vehicle body. In addition, the various components of the present invention can be sized and shaped so as to conform with various space limitations associated with a particular standard stock vehicle body without impairing the teachings and practice of the present invention. Other variations and modifications to the various components comprising the present invention are likewise envisioned and contemplated.

Thus, there has been shown and described a removably attachable rear loader attachment mechanism as well as a removably attachable winch mechanism for use on a standard stock refuse collection vehicle body. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not “as required”. Many changes, modifications, variations and other uses and applications of the present invention will, however, become apparent to those skilled in the art after considering the present specification and the accompanying drawings. All such changes, modifications, variations and other uses and applications which do not depart from the spirit and scope of the present invention are deemed to be covered by the invention which is limited only by the claims which follow.

1. A removably attachable rear loader attachment mechanism for attaching to a standard stock rear end refuse collection vehicle body, the rear end of the refuse collection vehicle body including a pair of side frame members, a cross frame member extending therebetween, and a top portion, the removably attachable rear loader attachment mechanism comprising:
a curb side latch assembly for removable attachment to one of said pair of vehicle side frame members;
a street side latch assembly for removable attachment to the other of said pair of vehicle side frame members;
a hopper extension member removably attachable to the vehicle cross frame member;
a curb side roller bar frame member pivotally attached to a channel flange member, the channel flange member being removably attachable to the street side latch assembly;
a street side roller bar frame member pivotally attached to a channel flange member, the channel flange member being removably attachable to the street side latch assembly;
a roller bar extending between the curb side and street side roller bar frame members;
the curb side and street side latch assemblies being movable to attach to a commercial container and the roller bar being movable to tilt a commercial container.

2. The removably attachable rear loader attachment mechanism of claim 1 wherein each of the curb side and street side latch assemblies include a frame member, and wherein the channel flange member associated with each curb side and street side roller bar frame member is removably attachable respectively to the corresponding frame member associated with the curb side and street side latch assemblies.

3. The removably attachable rear loader attachment mechanism of claim 1 wherein the latch assemblies each include a movable arm member and the roller bar channel flange members each include a hydraulic cylinder, the removably attachable rear loader attachment mechanism further including a hydraulic source attachable to the movable arm member of each of said latch assemblies for hydraulically moving each arm member between an open position and a latched position, and a hydraulic source attachable to each of the hydraulic cylinders associated with the roller bar channel flange members for hydraulically moving the roller bar between a first position and a second position angularly related thereto.

4. The removably attachable rear loader attachment mechanism of claim 1 including a winch mechanism removably attachable to the top portion of the standard stock rear end refuse collection vehicle body.

5. The removably attachable rear loader attachment mechanism of claim 4 wherein the winch mechanism includes a winch mounting cross frame member removably attachable to the top portion of the standard stock rear end refuse collection vehicle body, a winch attachable to a winch mounting frame, the winch mounting frame being removably attachable to the winch mounting cross frame member and to the top portion of the standard stock rear end refuse collection vehicle body.

6. A removably attachable winch mechanism for attaching to a top portion of a standard stock rear end refuse collection vehicle body, the removably attachable winch mechanism comprising:
a winch mounting cross frame member removably attachable to the top portion of the standard stock rear end refuse collection vehicle body, a winch attachable to a winch mounting frame member, the winch mounting frame member being removably attachable to the winch mounting cross frame member and to a flange member associated with the top portion of the standard stock rear end refuse collection vehicle body.

7. The removably attachable winch mechanism of claim 6 including hydraulic and electrical connections attachable to the winch mechanism.

8. A removably attachable rear loader attachment mechanism for attaching to a standard stock rear end refuse collection vehicle body, the rear end of the refuse collection vehicle body including a pair of side frame members, a cross frame member extending therebetween, and a top portion, the rear loader attachment mechanism comprising:
a curb side latch assembly for removably attachment to one of said pair of vehicle side frame members;
a street side latch assembly for removable attachment to the other of said pair of vehicle side frame members;
a hopper extension member removably attachable to the vehicle cross frame member; a curb side roller bar frame member removably attachable to the curb side latch assembly;
a street side roller bar frame member removably attachable to the street side latch assembly;
a roller bar extending between the curb side and street side roller bar frame members;
a winch mechanism removably attachable to the top portion of the standard stock rear end refuse collection vehicle body; and
the curb side and street side latch assemblies being movable to attach to a commercial container, the winch mechanism being attachable to a commercial container to tilt the commercial container, and the roller bar being movable to further tilt the commercial container.

9. The removably attachable rear loader attachment mechanism of claim 8 wherein the winch mechanism includes a winch mounting cross frame member removably attachable to the top portion of the standard stock rear end refuse collection vehicle body, a winch attachable to a winch mounting frame member, the winch mounting frame member being removably attachable to the winch mounting cross frame member and to a flange member associated with the top portion of the standard stock rear end refuse collection vehicle body.

10. The removably attachable rear loader attachment mechanism of claim 8 wherein the curb side and street side roller frame members each include a flange member which is removably attachable to the corresponding curb side and street side latch assemblies.
